(19) United States
(12) Patent Application Publication
(10) Pub. No.: US 2009/0013358 A1
(43) Pub. Date: Jan. 8, 2009

(54) Distributed video recording and playback

(76) Inventors: John A. Throckmorton, Lake Oswego, OR (US); Ajit P. Joshi, Portland, OR (US)

Correspondence Address: TROP PRUNER & HU, PC, 1616 S. VOSS ROAD, SUITE 750, HOUSTON, TX, 77057-2631, US

(21) Appl. No.: 12/283,344

(22) Filed: Sep. 11, 2008

Related U.S. Application Data
(63) Continuation of application No. 10/741,674, filed on Dec. 19, 2003.

(51) Int. Cl. H04N 7/18

(52) U.S. Cl. 725/80

(57) ABSTRACT

A method may include receiving a recording request for media information from a first media system. The method may also include selecting a source of the media information and selecting a storage destination for the media information. Recording and/or playback of the media information from the source to the storage destination may be scheduled.

### CROSS-REFERENCE TO RELATED APPLICATIONS

This application is a continuation of U.S. patent application Ser. No. 10/741,674, filed on Dec. 19, 2003.

### BACKGROUND

The claimed invention relates to exploiting media information and, more particularly, to recording and/or playback of media information.

Media systems may communicate with a source and/or conduit of media information (e.g., a communication channel or storage medium) and may also connect to one or more peripheral devices (e.g., televisions, displays, communication devices, etc.) for which the media information is destined. Media systems may be used to receive media information and route the information to one or more connected peripheral devices. Examples of media systems may include personal computers (PCs), set top boxes, consumer electronics (CE) devices such as digital versatile disc (DVD) players, and so forth. Control devices (e.g., remote controls or other input devices) may provide input to the media systems to assist in routing desired media information (e.g., television channels) to particular peripheral devices.

A single dwelling or structure may house multiple media systems, and these multiple media systems may access the same source and/or conduit of media information, or different sources/conduits. Individual media systems, however, typically may not be equipped to exploit resources in other media systems in their dwelling or structure.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. In the drawings,

FIG. 1 illustrates an example network consistent with the principles of the invention;

FIG. 2 illustrates an example media system in FIG. 1 consistent with the principles of the invention;

FIG. 3 illustrates a functional example of the network of FIG. 1 consistent with the principles of the invention;

FIG. 4 is a flow chart illustrating a process of recording media information consistent with the principles of the invention; and

FIG. 5 is a flow chart illustrating a process of playing media information consistent with the principles of the invention.

### DETAILED DESCRIPTION

The following detailed description refers to the accompanying drawings. The same reference numbers may be used in different drawings to identify the same or similar elements. Also, the following detailed description illustrates certain implementations and principles, but the scope of the claimed invention is defined by the appended claims and equivalents.

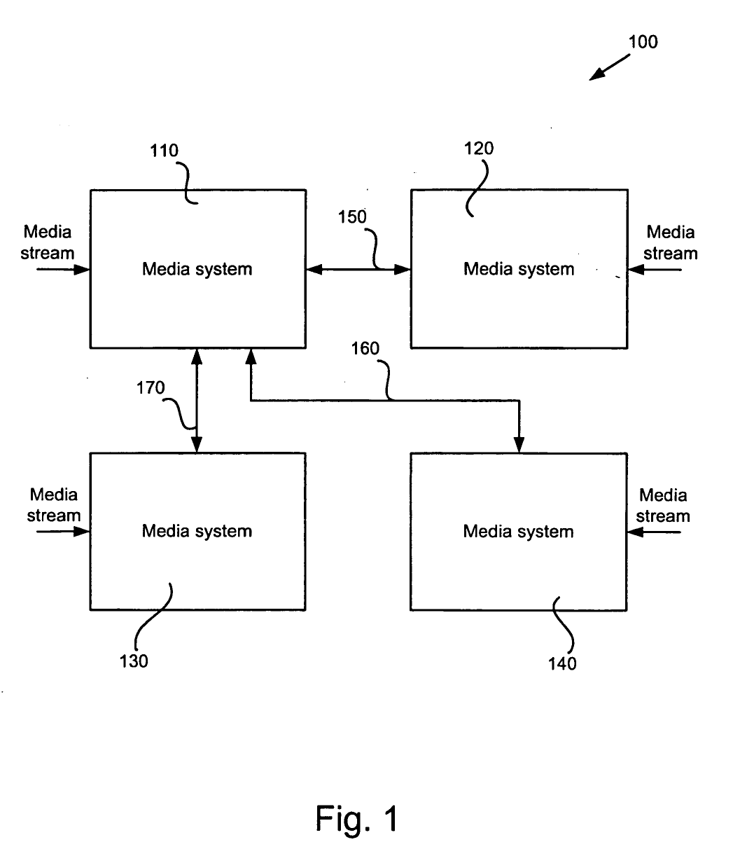

FIG. 1 illustrates an example network 100 consistent with the principles of the invention. Network 100 may include multiple media systems, such as media systems 110-140. Media systems 110-140 may be connected via communication links 150-170 so that they may intercommunicate. Although media systems 110-140 are illustrated in a hub-and-spoke arrangement, any configuration of communication links 150-170 is possible (including ad-hoc configurations) that facilitates direct or indirect communication among media systems 110-140.

As illustrated in FIG. 1, multiple instances of media systems 110-140 may be connected to media streams. The media streams may arrive from a source of media information via a wireless or wired communication link to some or all of media systems 110-140. The media streams may include one or more individual streams (e.g., channels) of media information. Sources of the media streams may include, but are not limited to, cable, satellite, or broadcast television providers. The media streams may also originate from a device, such as a video camera, playback device, a video game console, a remote device across a network (e.g., the Internet), or any other source of media information.

Media systems 110-140 may receive media information from the media stream and may output the same or different media information to a display or to another one of media systems 110-140. Some exemplary media systems 110-140 may include personal video recorders (PVRs), media centers, set-top boxes, enhanced playback devices (e.g., DVD players) and/or general-purpose or special-purpose computing devices, such as personal computers.

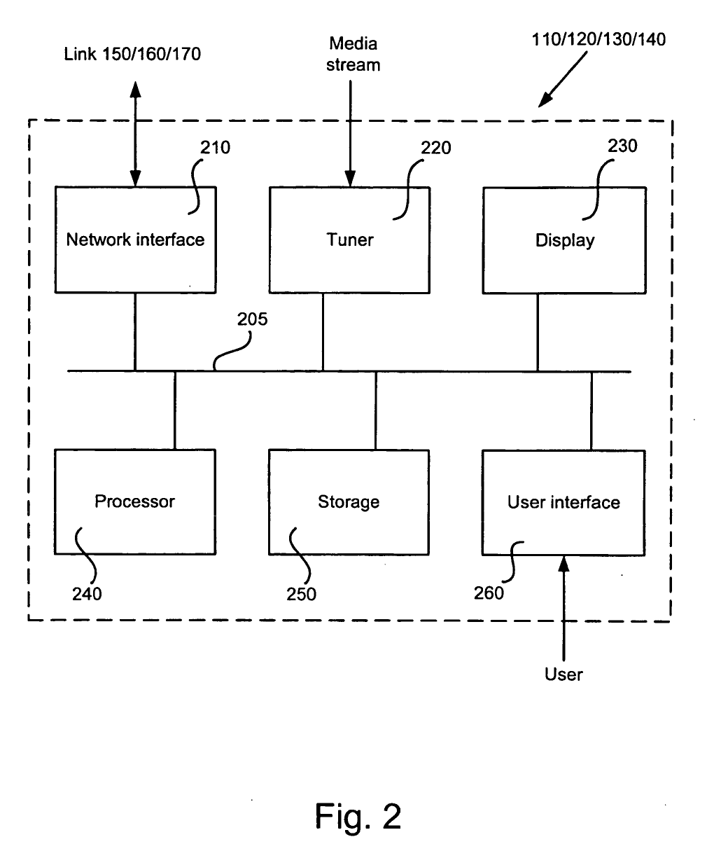

FIG. 2 illustrates an example implementation of media system 110/120/130/140 in network 100 consistent with the principles of the invention. Media system 110/120/130/140 may include at least some of a network interface 210, a tuner 220, a display 230, a processor 240, storage 250, and a user interface 260 connected by at least one bus 205. Although media system 110/120/130/140 may include some or all of elements 210-260, it may also include other elements that are not illustrated for clarity of explanation. Further, elements 210-260 may be implemented by hardware, software/firmware, or some combination thereof, and although illustrated as separate functional modules for ease of explanation, elements 210-260 may not be implemented as discrete elements within media system 110/120/130/140.

Further, it should be noted that not all of media systems 110, 120, 130, and 140 may be similarly configured, and that some media systems may not include certain ones of elements 210-260. Media system 120, for example, may lack storage 250. Other media systems, such as server-type systems, may lack one or more of tuner 220, display 230, and/or user interface 260.

Network interface 210 may be arranged to transmit and receive data via one or more of communication links 150-170. In some of media systems 110/120/130/140, network interface 210 may function as a switch or router, but in others of media systems 110/120/130/140, network interface 210 may function as an access point. Network interface 210 may be arranged to facilitate communication via any associated communication links 150-170. For example, if communication links 150-170 include a wireless link, network interface 210 may include circuitry and optionally an antenna arranged to send and receive wireless signals. Conversely, if communication links 150-170 include a wired link (including wires or other physical conduits such as optical fibers), network interface 210 may include circuitry and a connector arranged to send and receive signals via a wire, cable, fiber, or the like.

Tuner 220 may include one or more devices that are arranged to separate one or more streams of information (e.g., television channel(s)) from an input media stream. Tuner 220 may also include a physical interface to receive a transport medium (e.g., a coaxial cable) that carries the media stream. Tuner 220 may lock onto and output a first stream of information, such as a television channel or other information, present at a first frequency range in the media stream. The particular choice of which first stream or channel to be output by tuner 220 may be made by a user via user interface 260 or by processor 240 according to a scheduling and/or recording program as will be described in greater detail below.

Display 230 may include a television, monitor, projector, or other device suitable for displaying media information, such as video and/or audio. Display 230 may utilize a number of technologies for such displaying, including cathode ray tube (CRT), liquid crystal display (LCD), plasma, and/or projection-type technologies. In some situations, display 230 may receive media information to output from tuner 220. In other situations, display 230 may receive media information to output from network interface 210.

Processor 240 may interact with storage 250 (if present) and/or tuner 220 and/or network interface 210 to store and/or play media information. Processor 240 may, for example, play or store media information to/from “local” storage 250 and/or tuner 220. In some cases, however, processor 240 may play media information from, or store media information to, remote media systems via network interface 210, as will be described in further detail below.

In addition, processor 240 may also perform other associated tasks, such as encoding or decoding of media information before and/or after storage in storage 250 or transfer via network interface 210. For example, processor 240 may convert media information to or from various formats, such as MPEG-1, MPEG-2, MPEG-4 (from the Moving Picture Experts Group), or any other known or later-developed format. Processor 240 may also control which channels of information in the media stream are selected by tuner 220.

Storage 250 may include a solid-state, magnetic or optical storage medium, examples of which may include semiconductor-based memory, hard disks, optical disks, etc. Storage 250 may be arranged to store instructions and/or programs for execution by processor 240, as well as data products of the instructions and/or programs. Storage 250 may include random access memory (RAM), read only memory (ROM), flash memory, and may include other types of storage media, such as magnetic hard drives and (read-only or writable) optical media (e.g., compact discs (CDs), digital versatile discs (DVDs), etc.) and their associated optical drives.

User interface 260 may be arranged to supply input to a program on processor 240 from a user. User interface 260 may include, for example, a keyboard, mouse, remote control, multi-purpose controller or similar device. Although shown directly connected to processor 240 in FIG. 2, user interface 260 may, in some implementations, be functionally connected to processor 240 via an intermediate device, such as display 230.

Returning to FIG. 1, communication links 150-170 may include wireless and/or wired (e.g., electrically or optically conductive transport media) links among media systems 110-140. If a particular link of communication links 150-170 is a wired link, for example, an IEEE 802.11a link, an IEEE 802.11b link, an IEEE 802.11g link, or similar wireless links may be used. If a particular link of communication links 150-170 is a wired link, for example, a high speed Ethernet link, an IEEE 1394a or 1394b link, a synchronous optical network (SONET) link, or similar wired link may be used.

In other implementations, one or more of communication links 150-170 may not be separate from the link(s) providing the media streams. If media systems 110-140 are set-top boxes and the media streams are provided by a cable television provider, for example, media systems 110-140 may communicate and/or exchange information via the coaxial cable providing the media steams to each. Back-modulation of certain channels in the media stream may be used in conjunction with such operation.

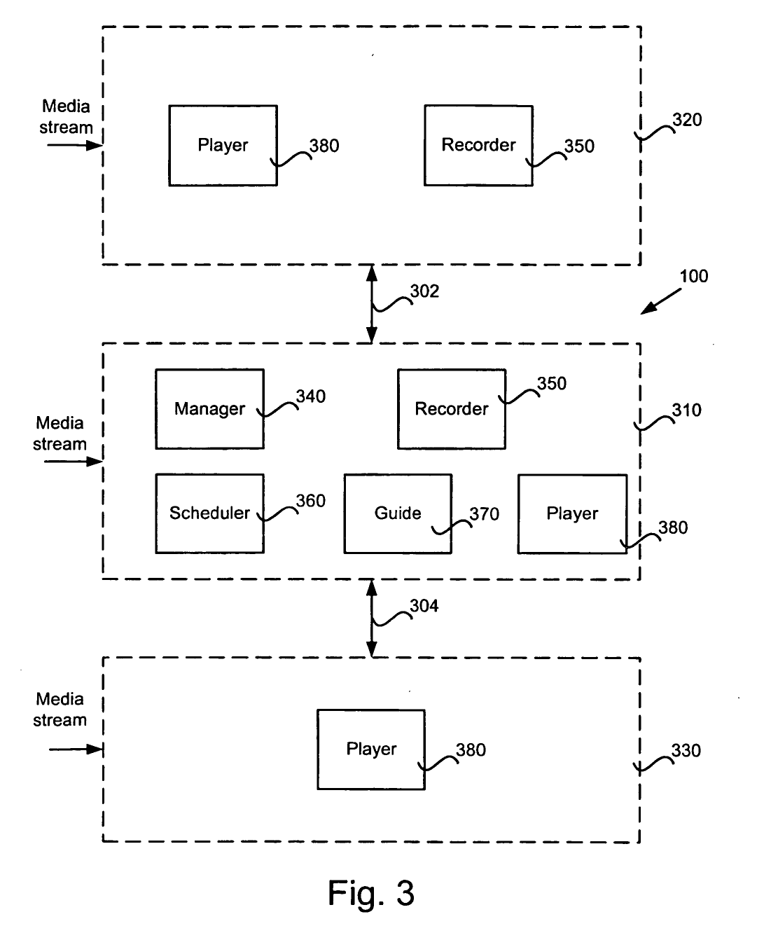

FIG. 3 illustrates a functional example of network 100 consistent with the principles of the invention. In this example, network 100 may include a first computer 310, a second computer 320, and a DVD player 330, all of which are examples of media systems 110-140. Although not explicitly illustrated in FIG. 3, each of computers 310/320 and DVD player 330 may include ones of elements 210-260 needed to perform its described function. First computer 310 may be connected to second computer 320 by a communication link 302, and may also be connected to network-enabled DVD player 330 by a communication link 304. DVD player 330 may indirectly communicate with second computer 320 via communication links 302 and 304.

Each of computers 310/320 and DVD player 330 may include certain ones of a manager 340, a recorder 350, a scheduler 360, a guide 370, and a player 380. Elements 340-380 may be modular programs to be executed by processor 240 in computers 310/320 and DVD player 330. Which ones of elements 340-380 are present may be determined by the configuration and capabilities of a particular media system. For example, in some implementations DVD player 330 may not include a hard disk, so it also may not include recorder 350.

It should be noted that elements 340-380 are described as separate functional elements for ease of explanation only, and some or all of elements 340-380 may be combined in a single program or application. For example, in some implementations, manager 340 and scheduler 360 may be combined. In other implementations, however, recorder 350 and scheduler 360 may be combined. Nor are all of elements 340-380 necessarily resident in a single media system. A guide 370 (or at least data therefore) may be provided to all of computers 310/320 and DVD player 330 via the provider of the media streams.

Manager 340 may manage available resources on network 100. For example, manager 340 may keep track of which media systems in network 100 have which resources, and may also resolve conflicting demands on those resources. For example, manager 340 may determine to route media information from a tuner 220 in one system (e.g., second computer 320) to another system (e.g., first computer 310) via communication link 302 for recording on storage 250 in that system. In other implementations, manager 340 may implement a preference for local recording within a system, such as second computer 320, whenever possible.

Recorder 350 may record media information to storage 250 resident in a media system, such as first computer 310 or second computer 320. Recorder 350 in a particular media system may record media information from a number of sources, such as the associated media stream, a communication link 302/304, and/or an source of media information (e.g., a DVD) associated with the media system.

Scheduler 360 may instruct a particular recorder 350 to record media information from a particular source (e.g., a media stream or a communication link 302/304) at a particular time. Scheduler 360 may determine which recorder 350 and source in which media system to utilize for a desired piece of media information (e.g., television program), or in some implementations, scheduler 360 may receive information from manager 340 on which destination media system and which source of media information to schedule for recording.

Guide 370 may include a service that lists media information (e.g., television programs) on channels of media stream. Guide 370 may also provide other information, such as what times the programs are on and/or any associated content information along with associated metadata. Guide 370 may receive associated data about media stream either from the media stream itself, or from some other source (e.g., a communication network, such as the Internet). In some implementations, guide 370 may also list stored media information (e.g., recorded by recorder 350) that is available for playback.

Player 380 may display media information on display 230 from a media stream (via tuner 220), from a communication link 302/304 (via network interface 210) and/or from a local storage device 250 (e.g., a DVD, hard disk, etc.). In addition to an ability to control tuner 220, player 380 may also route (e.g., “play”) media information to another media system (e.g., second computer 320 or DVD player 330) via network interface 210. Thus player 380 in DVD player 330 may make media information from its local tuner 220 or from a DVD available to one or more of first computer 310 and second computer 320 via communication link 304.

Each of the first computer 310, second computer 320, and DVD player 330 may automatically advertise the availability of the services they provide to other media systems on network 100. Such advertisement may occur during initial connection of the media system 310/320/330 to network 100 and/or powering-on of the media system, and may be broadcast via a number of known announcement/discovery schemes. One example of a communication scheme that may be used for media system advertisement/discovery may be that promulgated by the Zero Configuration Networking (Zeroconf) working group of the Internet Engineering Task Force (IETF), or a similar scheme.

Together in network 100, the functional elements 340-380 in first computer 310, second computer 320, and DVD player 330 may form a combined application, in which the combined resources of each of first computer 310, second computer 320, and DVD player 330 may be used upon request. In FIG. 3, for example, network 100 may include three players 380 with the ability to display and/or stream media data any tuner 220 or storage 250 in the network. Similarly, network 100 may include two recorders 350 with the ability to record media data from any source in network (e.g., tuners 220 or storage devices 250).

Thus, communication links 302/304 enable use of all resources present in media systems 310/330 of network 100, for example the three tuners 220 (not shown) associated with the three media streams shown. Any media system (e.g., DVD player 330) in network 100 may control the recording of multiple television shows, for example, at the same time. In addition, any media system (e.g., DVD player 330) in network 100 may play back a recorded television show, for example, even if it did not record the media information or does not store the stored media information.

Each of first computer 310, second computer 320, and DVD player 330 may be located remote from the others, for example in different rooms or locations in a building or dwelling. Network 100 enables media information (e.g., television programs) to be scheduled, recorded, and/or played back from multiple locations in the building or dwelling.

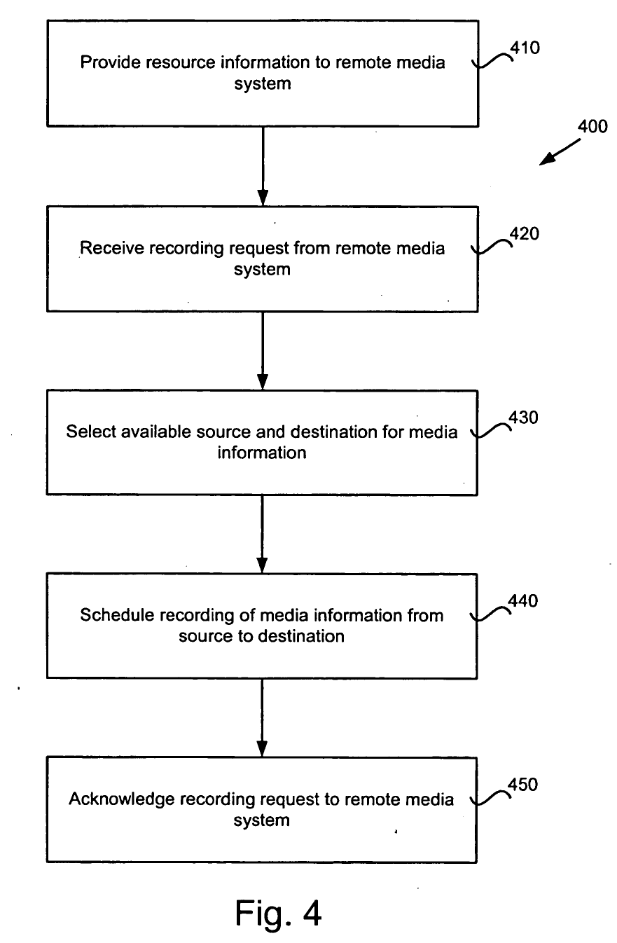

FIG. 4 is a flow chart illustrating a process 400 of recording media information consistent with the principles of the invention. Although process 400 will be described with regard to the example network 100 in FIG. 3, it is also applicable to network 100 in FIG. 1. In one room, a user may access a special network video option in player 380 of DVD player 330. In response, DVD player 330 may remotely access manager 340 on first computer 310 via communication link 304.

Processing may begin with manager 340 on first computer 310 providing resource information to DVD player 330 via communication link 302 [act 410]. The resource information may include a list of options, one of which may include utilization of guide 370 on first computer 310 to schedule media information (e.g., a television show) to be recorded. When the user has determined the desired media information, a recording request may be sent to first computer 310 via user interface 260 and network interface 210 of DVD player 310.

Manager 340 on first computer 310 may receive the recording request from DVD player 330 via communication link 302 [act 420]. In servicing this request, the manager 340 and/or scheduler 360 on first computer 310 may select from available tuner 220, storage 250 and recorder 350 resources on network 100 [act 430]. For example, tuner 220 on second computer 320 may be selected as a source of the media information, and storage 250 of first computer 310 may be selected as the storage destination. In other implementations, storage 250 on second computer 320 may be selected as the destination to avoid sending the media information over communication link 302.

Scheduler 360 on first computer 310 may schedule the media information to be recorded from the source to the destination selected in act 430 [act 440]. In some implementations, recording may begin immediately, but in others scheduler 360 may instruct recorder 350 in first computer 310, for example, to begin sending media information to the destination at a future time.

After scheduling, manager 340 may acknowledge the recording address of DVD player 330 via communication link 304 [act 450]. If recording will proceed (e.g., if enough resources exist in network 100 to record the requested media information), manager 340 may send DVD player 330 a “recording scheduled” or similar message. If, however, there are not enough resources to record the desired media information, DVD player 330 may receive a message in act 450 that the requested recording will not occur. In this manner, DVD player 330 may record media information, such as television shows, using other resources within network 100.

In some implementations, scheduler 360 and manager 340 may be present in multiple media systems (e.g., first and second computers 310 and 320). In such an implementation, the various schedulers 360 and managers 340 may communicate with each other as soon as their respective services start (e.g., upon power-up, connection, etc.). In other implementations, scheduler 360 and manager 340 may be present in a single media system (e.g., first computer 310). In such an implementation, scheduler 360 and manager 340 may control and/or coordinate all media information to be recorded and/or played, provided that all of the media systems present on network 100 are registered with them

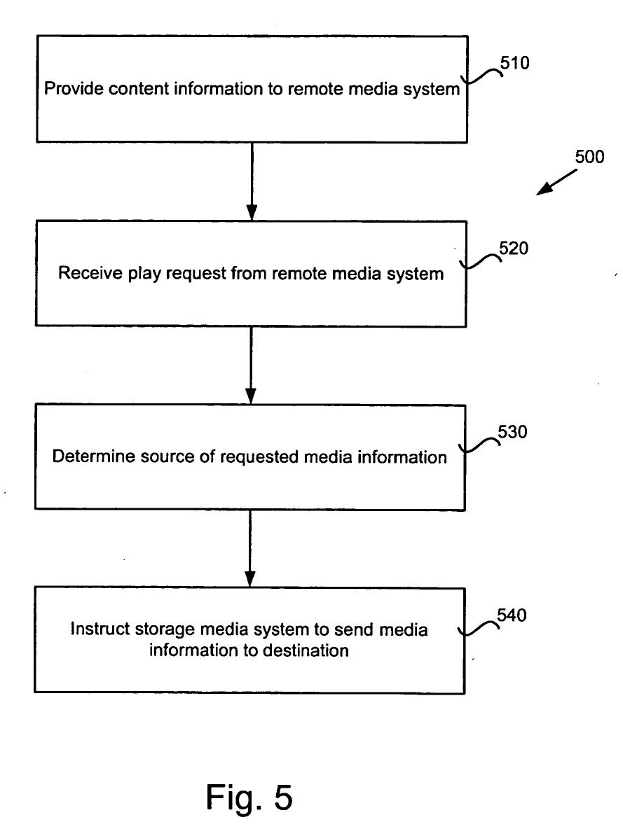

FIG. 5 is a flow chart illustrating a process 500 of playing media information consistent with the principles of the invention. Although process 500 will be described with regard to the example network 100 in FIG. 3, it is also applicable to network 100 in FIG. 1. In one room, a user may access a network playback option in player 380 of DVD player 330. In response, DVD player 330 may remotely access manager 340 on first computer 310 via communication link 304 to request a list of available recorded media information.

Processing may begin with manager 340 on first computer 310 providing content information to DVD player 330 via communication link 302 [act 510]. The content information may include a list of recorded media information (e.g., television shows, movies, etc.) to be played. When the user selects the desired media information, a play request may be sent to first computer 310 via user interface 260 and network interface 210 of DVD player 310. In some implementations, the play request may specify DVD player 310 as the destination of the media information to be played.

Manager 340 on first computer 310 may receive the play request from DVD player 330 via communication link 302 [act 520]. In servicing this request, the manager 340 and/or scheduler 360 on first computer 310 may determine a source of the requested media information [act 530]. For example, manager 340 may determine via a look-up table that the requested media information is stored in storage 250 of second computer 320. In other implementations consistent with the principles of the invention, manager 340 may poll other media systems (e.g., second computer 320) in network 100 to determine which one contains the requested media information.

Manager 340 may instruct the media system that contains the requested information (e.g., second computer 320) to send it to the requesting media system (e.g., DVD player 330) [act 540]. The instruction for the media system that contains the requested information (e.g., second computer 320) may include an address of, or path to, the requesting media system (e.g., DVD player 330). For example, player 380 in second computer 320 may send the requested media information from storage 250 through network interface 210 to DVD player 330 via communication links 302 and 304. Player 380 in DVD player 330 may display the media information received on its network interface 210. In this manner, DVD player 330 may play stored media information, such as television shows, using other resources within network 100.

The foregoing description of one or more implementations consistent with the principles of the invention provides illustration and description, but is not intended to be exhaustive or to limit the claimed invention to the precise form disclosed. Modifications and variations are possible in light of the above teachings or may be acquired from practice of the invention.

For example, network 100 may include a local area network (LAN) that includes communication links 150/160/170, but additionally or alternatively may incorporate other communication schemes. For example, media systems 110-140 in network 100 may communicate, for example, via communication links from media content providers, such as coaxial cables, Internet connections, or satellite links that carry the media streams. The media content provider may assist in, for example, tracking resources available within a particular household. Media information may be sent from one media system 110 to another media system 120 by various techniques, such as back-modulation on a common channel in the media stream.

Further, implementations consistent with the principles of the invention are not limited to computers or consumer electronics devices. Set-top boxes (e.g., including only a tuner 220 and network interface 210) may be connected to one or more computers, which may record media information from the set-top box, and which may also control the set-top boxes remotely by software.

In accordance with the foregoing, multiple tuners 220 may be available in a home network 100. Instead of binding a particular tuner 220 to a particular device 110/120 (e.g., a PC or a media center), however, it may be shared among multiple devices 110/120/130/140 in network 100 by using manager 340 and/or scheduler 360. So arranged, network 100 may constitute a functional meta-PVR that may record and/or play multiple sources of media information at the same time using its various resources.

Moreover, the acts in FIGS. 4 and 5 need not be implemented in the order shown; nor do all of the acts necessarily need to be performed. Also, those acts that are not dependent on other acts may be performed in parallel with the other acts. Further, the acts in this figure may be implemented as instructions, or groups of instructions, implemented in a machine-readable medium.

No element, act, or instruction used in the description of the present application should be construed as critical or essential to the invention unless explicitly described as such. Also, as used herein, the article “a” is intended to include one or more items. Where only one item is intended, the term “one” or similar language is used. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method, comprising:
networking two distinct media-playing systems, each media-playing system including video resources, including a tuner, that may be accessed and used by the other media-playing systems; and
a manager to keep track of the availability of resources on each system, to assign resources in response to a resource request and to arbitrate conflicting resource requests.

2. The method of claim 1, including enabling a tuner on one system to be used by the other system.

3. The method of claim 1, including providing the manager on one of said systems.

4. The method of claim 1, including sharing at least one of a video recording resource, a scheduling resource, a guide resource, and a display.

5. The method of claim 1, including networking at least three distinct media-playing systems, each system including video resources such that resources on any one of the three systems may be accessed and used by any of the other three systems.
